(19) United States
(12) Patent Application Publication
(10) Pub. No.: US 2010/0207785 A1
(43) Pub. Date: Aug. 19, 2010

(54) SLAG DISCHARGE CONDITION MONITORING APPARATUS AND METHOD FOR MONITORING SLAG DISCHARGE CONDITION

(75) Inventors: Naoki Suganuma, Nagasaki (JP); Tetsuya Yamada, Nagasaki (JP); Mutsuaki Taguchi, Nagasaki (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/678,664

(22) PCT Filed: Jun. 18, 2008
(86) PCT No.: PCT/JP2008/061118

§ 371 Date: Mar. 17, 2010

(30) Foreign Application Priority Data
Feb. 29, 2008 (JP) 2008-051052

(51) Int. Cl. G08B 21/18

(52) U.S. Cl. 340/870.16

(57) ABSTRACT

A slag discharge condition monitoring apparatus and a method for monitoring a slag discharge condition that are capable of preventing the detection accuracy of the slag discharge condition from being lowered due to scaling-up of a coal gasification facility, especially a coal gasification furnace, are provided. A slag discharge condition monitoring apparatus to be mounted in a furnace facility that processes molten slag produced within a furnace by dripping the molten slag from a slag hole provided on a furnace bottom into cooling water outside the furnace includes an underwater microphone provided in the cooling water substantially equidistant from each of a pair of slag taps that are disposed opposite each other and that cause the molten slag to flow into a slag hole.

### RELATED APPLICATIONS

The present application is national phase of International Application Number PCT/JP2008/061118 filed Jun. 18, 2008, and claims priority from Japanese Patent Application Number 2008-051052, filed Feb. 29, 2008, the disclosures of which are hereby incorporated by reference herein in their entirety.

### TECHNICAL FIELD

The present invention relates to a slag discharge condition monitoring apparatus and to a method for monitoring a slag discharge condition, which are utilized in commercial or industrial coal gasification facilities.

### BACKGROUND ART

In conventional coal gasification facilities, ash after combustion accumulates as molten slag on a bottom part of a combustion furnace and flows and falls into a slag hopper disposed therebelow from a slag tap of a slag hole. Cooling water is pooled within the slag hopper, and the molten slag is discharged to the exterior of the system after being cooled and solidified by the cooling water.

A slag discharge condition monitoring apparatus used for a coal gasification facility monitors the dripping of the molten slag into the slag hopper, and so far, a technique for monitoring the dripping condition of the molten slag using a monitoring television camera, a technique for monitoring the dripping condition of the molten slag by detecting sound produced when the molten slag drips into the cooling water using an underwater microphone, and so forth have been proposed (for example, see Patent Citation 1).

Patent Citation 1: the Publication of Japanese Patent No. 2566357

### DISCLOSURE OF INVENTION

With the monitoring method using the television camera, there are problems in that the visibility around the slag hole is low and monitoring of the discharge condition of the slag cannot be sufficiently conducted compared with the monitoring method using the underwater microphone; and in that the molten slag is also cooled and solidified by air for cooling the television camera, which tends to inhibit the ability to discharge slag.

On the other hand, with the monitoring method using the underwater microphone described in Patent Citation 1, there is a problem in that, because the mounting position of the underwater microphone is not specified in relation to the position of the slag tap, if the positional relationship between the underwater microphone and the above-described entry point into water is changed due to the operating conditions as a consequence of scaling-up the coal gasification facility, the level of the underwater sound detected by the underwater microphone is changed, and therefore, there is a risk that the detection accuracy of the slag discharge condition is lowered.

The present invention has been conceived in order to solve the problems described above, and an object thereof is to provide a slag discharge condition monitoring apparatus and a method for monitoring a slag discharge condition that are capable of preventing the detection accuracy of the slag discharge condition from being lowered due to scaling-up of the coal gasification facility, especially the coal gasification furnace.

In order to realize the above-described object, the present invention provides the following solutions.

A first aspect of the present invention provides a slag discharge condition monitoring apparatus provided in a furnace facility that processes molten slag produced within a furnace by dripping the molten slag from a slag hole provided on a furnace bottom into cooling water outside the furnace, the slag discharge condition monitoring apparatus including an underwater microphone that is provided in the cooling water substantially equidistant from each of a pair of slag taps that are disposed opposite each other and that cause the molten slag to flow into the slag hole.

According to the first aspect of the present invention, because the underwater microphone is disposed substantially equidistant from each of the pair of slag taps, even if the amount of molten slag flowing out from the pair of slag taps is biased towards one of the slag taps, for example, the influence of the decrease of the sound pressure level detected by the underwater microphone is reduced.

In other words, if the amount of molten slag flowing out from the other slag tap is decreased, the sound pressure level of the underwater sound produced when this molten slag drips into the cooling water is lowered, and the sound pressure level for the other slag tap detected by the underwater microphone is lowered. On the other hand, because the sound pressure level of the underwater sound produced by the molten slag flowing out from the one slag tap is not lowered, the sound pressure level for the one slag tap detected by the underwater microphone is not lowered.

In other words, because the underwater microphone is disposed at the point where the distance from the one slag tap and the distance from the other slag tap are substantially equal, the influence of the decrease of the sound pressure level is reduced compared with a case where the other slag tap is disposed at a closer position, for example.

In the first aspect of the above-described invention, it is desirable that the underwater microphones are a pair of underwater microphones disposed opposite each other and equidistant from each of the pair of slag taps, and that a computing unit that calculates an average value of the sound pressure levels detected by the pair of underwater microphones is provided.

By doing so, because each of the pair of underwater microphones is disposed substantially equidistant from each of the slag taps, even if entry points into the water of the molten slag flowing out from the pair of slag taps are, for example, deviated towards the side of one of the underwater microphones, because the pair of underwater microphones is used for the detection, the influence of the decrease of the sound pressure level is reduced. In addition, because the average value of the sound pressure levels detected by each of the underwater microphones is calculated, the influence of the decrease of the sound pressure levels detected by the underwater microphone becomes even smaller.

For example, if the pair of slag taps are disposed between the pair of underwater microphones, even if the positions where the molten slag drips into the cooling water are deviated towards the side of one of the underwater microphones, the influence of the decrease of the sound pressure levels detected by the underwater microphones is reduced. Specifically, while the sound pressure level detected by one underwater microphone is increased, the sound pressure level detected by the other underwater microphone is lowered. Therefore, the influence of the decrease of the sound pressure levels detected by the pair of underwater microphones becomes small.

A second aspect of the present invention provides a slag discharge condition monitoring apparatus including, in a furnace facility that processes molten slag produced within a furnace by dripping the molten slag from a slag hole provided on a furnace bottom into cooling water outside the furnace: a pair of underwater microphones that are disposed opposite each other in the cooling water and a pair of slag taps that are disposed opposite each other and that cause the molten slag to flow into the slag hole, each of the pair of underwater microphones and each of the pair of slag taps being disposed on substantially the same line; and a computing unit that calculates an average value of sound pressure levels detected by the pair of underwater microphones.

According to the second aspect of the present invention, by calculating the average value of the sound pressure levels of the underwater sound measured by the pair of underwater microphones, even if the amount of molten slag flowing out from the pair of slag taps is biased towards one of the slag taps, for example, the influence of the decrease of the sound pressure levels detected by the underwater microphones is reduced.

In the second aspect of the above-described invention, it is desirable that a determination unit that determines the presence and absence of the molten slag dripping into the cooling water from one and the other of the pair of slag taps, respectively, on the basis of the difference between the sound pressure levels detected by the pair of underwater microphones is provided.

By doing so, the difference between the sound pressure levels detected by the pair of underwater microphones is obtained, and thereby, the presence and absence of the molten slag dripping at one and the other of the pair of slag taps is determined.

In the first aspect of the above-described invention, it is desirable that a determination unit that calculates sound pressure levels in a plurality of frequency bands of underwater sound detected by the underwater microphone and that determines a dripping state of the molten slag on the basis of the sound pressure levels in each frequency band is provided.

By doing so, the dripping state of the molten slag, for example, states such as non-dripping, continuous-dripping, and intermittent-dripping, is determined on the basis of the sound pressure levels in a plurality of frequency bands. In other words, if the dripping state of the molten slag is changed, the waveform of the underwater sound produced when the molten slag and the cooling water are brought into contact will also change. Therefore, based on the sound pressure levels in a plurality of frequency bands, it is possible to determine to which dripping state-related underwater sound the detected underwater sound corresponds, and thus it is possible to determine the dripping state of the molten slag.

A third aspect of the present invention provides a slag discharge condition monitoring apparatus including, in a furnace facility that processes molten slag produced within a furnace by dripping the molten slag from a slag hole provided on a furnace bottom into cooling water outside the furnace: an underwater microphone disposed in the cooling water; and a determination unit that calculates sound pressure levels in a plurality of frequency bands of underwater sound detected at the underwater microphone, and that determines a dripping state of the molten slag on the basis of the sound pressure level in each frequency band.

According to the third aspect of the present invention, the dripping state of the molten slag, for example, states such as non-dripping, continuous-dripping, and intermittent-dripping, is determined on the basis of the sound pressure levels in a plurality of frequency bands. In other words, if the dripping state of the molten slag is changed, the waveform of the underwater sound produced when the molten slag and the cooling water are brought into contact will also change. Therefore, based on the sound pressure levels in a plurality of frequency bands, it is possible to determine to which dripping state-related underwater sound the detected underwater sound corresponds, and thus it is possible to determine the dripping state of the molten slag.

A fourth aspect of the present invention provides a method for monitoring a slag discharge condition in a furnace facility that processes molten slag produced within a furnace by dripping the molten slag from a slag hole provided on a furnace bottom into cooling water outside the furnace, the method for monitoring a slag discharge condition including: a detection step of detecting the underwater sound in the cooling water by an underwater microphone disposed in the cooling water; and a determination step of determining the dripping state of the molten slag into the cooling water on the basis of the detected sound pressure level of the underwater sound.

According to the fourth aspect of the present invention, the dripping state of the molten slag, for example, states such as non-dripping, continuous-dripping, and intermittent-dripping, is determined on the basis of the sound pressure level of the underwater sound detected by the underwater microphone. In other words, if the dripping state of the molten slag is changed, the sound pressure level of the underwater sound produced when the molten slag and the cooling water are brought into contact will also change. Based on this sound pressure level, it is possible to determine to which dripping state-related underwater sound the detected underwater sound corresponds, and thus, it is possible to determine the dripping state of the molten slag.

With the slag discharge condition monitoring apparatus according to the first aspect of the present invention, because the underwater microphone is disposed substantially equidistant from each of the pair of slag taps, even if the amount of molten slag flowing out from the pair of slag taps is, for example, biased towards one of the slag taps, because the influence of the decrease of the sound pressure level detected by the underwater microphone becomes small, an advantage is afforded in that the lowering of the detection accuracy of the slag discharge condition due to scaling-up of the coal gasification facility, especially the coal gasification furnace, can be prevented.

With the slag discharge condition monitoring apparatus according to the second aspect of the present invention, by calculating the average value of the sound pressure levels of the underwater sound measured by the pair of underwater microphones, even if the amount of molten slag flowing out from the pair of slag taps is, for example, biased towards one of the slag taps, because the influence of the decrease of the sound pressure levels detected by the underwater microphones become small, an advantage is afforded in that the lowering of the detection accuracy of the slag discharge condition due to scaling-up of the coal gasification facility, especially the coal gasification furnace, can be prevented.

With the slag discharge condition monitoring apparatus according to the third aspect of the present invention, the dripping state of the molten slag, for example, states such as non-dripping, continuous-dripping, and intermittent-dripping, is determined on the basis of the sound pressure levels in a plurality of frequency bands; therefore, an advantage is afforded in that the lowering of the detection accuracy of the slag discharge condition due to scaling-up of the coal gasification facility, especially the coal gasification furnace, can be prevented.

With the method for monitoring a slag discharge condition according to the fourth aspect of the present invention, the dripping state of the molten slag, for example, states such as non-dripping, continuous-dripping, and intermittent-dripping, is determined on the basis of the sound pressure level; therefore, an advantage is afforded in that the lowering of the detection accuracy of the slag discharge condition due to scaling-up of the coal gasification facility, especially the coal gasification furnace, can be prevented.

### BRIEF DESCRIPTION OF DRAWINGS

FIG. 1 is a top view for explaining the configuration of a slag discharge condition monitoring apparatus according to a first embodiment of the present invention.

FIG. 2 is a cross-sectional view taken along A-A for explaining, in outline, the slag discharge condition monitoring apparatus of FIG. 1.

FIG. 3 is a top view for explaining the configuration of a slag discharge condition monitoring apparatus according to a second embodiment of the present invention.

FIG. 4 is a cross-sectional view taken along B-B for explaining, in outline, the slag discharge condition monitoring apparatus of FIG. 3.

FIG. 5 is a top view for explaining the configuration of a slag discharge condition monitoring apparatus according to a third embodiment of the present invention.

FIG. 6 is a cross-sectional view taken along C-C for explaining, in outline, the slag discharge condition monitoring apparatus of FIG. 5.

FIG. 7 is a cross-sectional view for explaining the configuration of a slag discharge condition monitoring apparatus according to a fourth embodiment of the present invention.

FIG. 8 is a cross-sectional view for explaining the configuration of a slag discharge condition monitoring apparatus according to a fifth embodiment of the present invention.

FIG. 9 is a graph for explaining a relationship between waveforms and frequency bands of underwater sound detected by the hydrophones in FIG. 8.

FIG. 10 is a diagram for explaining a map used for determination of a dripping state of molten slag in a determination unit in FIG. 8.

FIG. 11 is a diagram for explaining a map used for determination of a dripping state of molten slag in a determination unit in FIG. 8.

### EXPLANATION OF REFERENCE

1, 101, 201, 301, 401: slag discharge condition monitoring apparatus
2, 102, 202: hydrophone (underwater microphone)
103, 303: determination unit (computing unit)
50: combustion furnace (furnace facility)
51: combustion furnace main body (furnace)
52: furnace bottom
54: slag hole
55: slag tap
403: determination unit

### BEST MODE FOR CARRYING OUT THE INVENTION

### First Embodiment

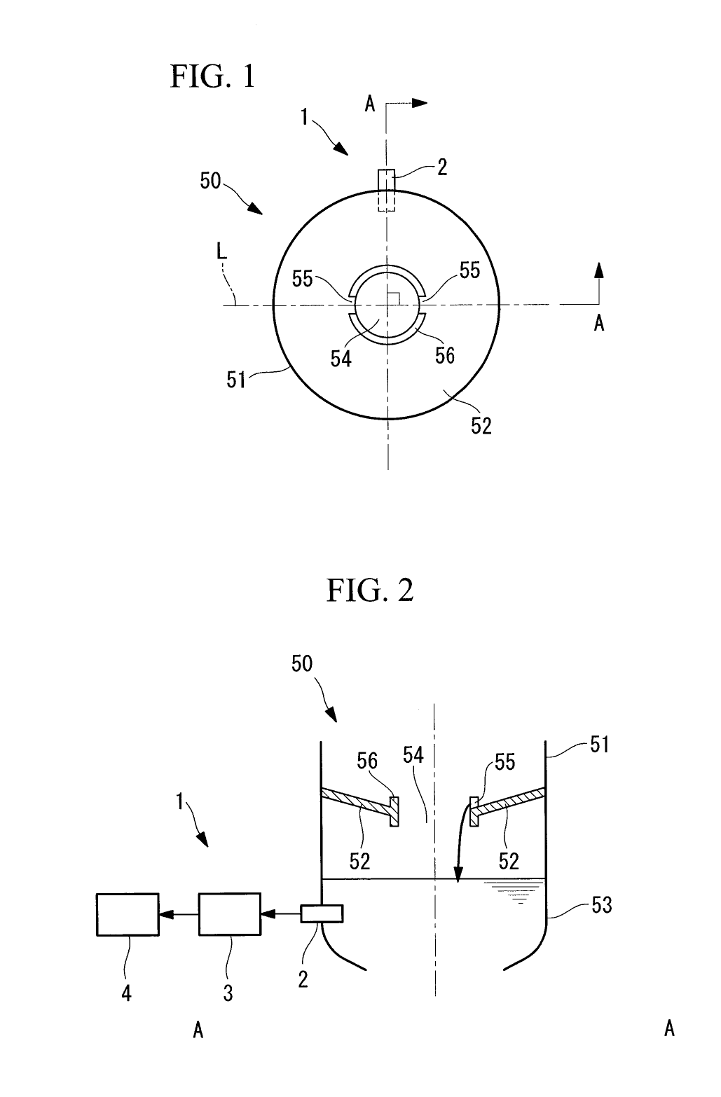

A slag discharge condition monitoring apparatus according to a first embodiment of the present invention will be described below with reference to FIGS. 1 and 2.

FIG. 1 is a top view for explaining the configuration of a slag discharge condition monitoring apparatus according to this embodiment. FIG. 2 is a cross-sectional view taken along A-A for explaining, in outline, the slag discharge condition monitoring apparatus of FIG. 1.

As shown in FIGS. 1 and 2, a slag discharge condition monitoring apparatus 1 of this embodiment is provided in a combustion furnace (furnace facility) 50 of a coal gasification furnace in a coal gasification facility, and the slag discharge condition monitoring apparatus 1 monitors the discharge condition of molten slag produced within the combustion furnace 50 and issues a warning when the molten slag is not dripping or is dripping intermittently.

The combustion furnace 50 is provided with a combustion furnace main body (furnace) 51 inside of which pulverized coal and char are combusted, a furnace bottom 52 onto which ash after combustion is accumulated as molten slag, a slag hopper 53 that stores cooling water for cooling the molten slag, a slag hole 54 that introduces the molten slag from the furnace bottom 52 into the cooling water, and slag taps 55 that are notches through which the molten slag flows into the slag hole 54 from the furnace bottom 52.

The combustion furnace main body 51 generates combustible gases from coal by combusting the pulverized coal and the char charged inside. In addition, the molten slag, which is molten ash after the combustion, is produced within the combustion furnace main body 51.

Because a swirling flow is formed within the combustion furnace main body 51, the molten slag flows down towards the furnace bottom 52 disposed below while adhering to the inner circumferential surface of the combustion furnace main body 51.

The furnace bottom 52 is a disc-shaped member disposed at the lower part of the combustion furnace main body 51, and it has a surface inclined downwards towards the center of the combustion furnace main body 51. The slag hole 54 that introduces the molten slag into the cooling water in the slag hopper 53 is disposed substantially at the center of the furnace bottom 52.

With this configuration, the molten slag flowing down from the combustion furnace 50 is introduced into the slag hole 54 at the center of the combustion furnace main body 51.

The slag hole 54 introduces the molten slag from the furnace bottom 52 into the cooling water in the slag hopper 53, and is formed by a substantially cylindrical wall portion 56. The wall portion 56 is disposed so that the upper end is protruded upward from the furnace bottom 52 and the lower end is extended towards the cooling water in the slag hopper 53.

The slag taps 55 are the notches through which the molten slag flows into the slag hole 54 from the furnace bottom 52. Specifically, the slag taps 55 are a pair of notches formed on the wall portion 56 that protrudes upward from the furnace bottom 52 and are disposed opposite each other on the line L passing through the center of the slag hole 54.

With this configuration, the molten slag flowing on the furnace bottom 52 towards the slag hole 54 is temporarily pooled by the wall portion 56 that protrudes upward and flows into the slag hole 54 from the slag taps 55. The molten slag flowing into the slag hole 54 drips into the cooling water below.

The molten slag drips into the cooling water either continuously or intermittently depending on the operating state of the coal gasification furnace, in other words, the conditions inside the combustion furnace 50.

A slag discharge condition monitoring apparatus 1 is provided with a hydrophone (underwater microphone) 2 that detects underwater sound in the cooling water in the slag hopper 53, a determination unit 3 that determines the dripping state of the molten slag on the basis of the underwater sound detected, and a warning unit 4 that issues a warning on the basis of the determination result.

As shown in FIGS. 1 and 2, the hydrophone 2 is disposed in the cooling water in the slag hopper 53, and at the same time, is disposed at a position equidistant from the pair of slag taps 55. In other words, the hydrophone 2 is disposed on the line extending substantially perpendicular to the line L from the midpoint of the pair of slag taps 55.

The determination unit 3 determines the presence and absence etc. of the molten slag dripping into the cooling water from the pair of slag taps 55 on the basis of the sound pressure level of the underwater sound detected by the hydrophone 2 and outputs a control signal for controlling the warning issued from the warning unit 4 on the basis of this determination.

A detection signal output from the hydrophone 2 is input to the determination unit 3 and the control signal is output from the determination unit 3 to the warning unit 4.

The warning unit 4 issues the warning to the operator of the coal gasification facility and so forth on the basis of the control signal from the determination unit 3.

Next, the operation of the slag discharge condition monitoring apparatus 1 of the above-described configuration will be described.

As shown in FIGS. 1 and 2, when the molten slag drips into the cooling water in the slag hopper 53, the molten slag is cooled and solidified. At this time, the cooling water brought into contact with the molten slag is evaporated and a sound is produced upon evaporation. In addition, an entry sound is also produced when the molten slag enters the cooling water.

The sound produced upon evaporation of the cooling water, the entry sound, and so forth propagate within the cooling water and are detected by the hydrophone 2. The detection signal of the underwater sound detected by the hydrophone 2 is input to the determination unit 3.

With the determination unit 3, the sound pressure level of the underwater sound detected by the hydrophone 2 is estimated on the basis of the input detection signal. If the value of the estimated sound pressure level is changed when the coal gasification facility is operated normally, the determination unit 3 determines that the dripping state of the molten slag has changed.

Specifically, in the case where the molten slag is set to drip continuously under the normal operation of the coal gasification facility, if the value of the sound pressure level is lowered, the determination unit 3 determines that it has entered a state where the molten slag is not dripping, and on the other hand, if the value of the sound pressure level is increased, the determination unit 3 determines that it has entered a state where the molten slag is dripping intermittently.

The determination unit 3 outputs the control signal indicating whether or not the warning is to be issued to the warning unit 4 on the basis of the determined dripping state of the molten slag. For example, if the dripping state of the molten slag is either intermittent dripping or non-dripping, the determination unit 3 outputs the control signal for issuing the warning to the warning unit 4.

The warning unit 4, to which the control signal has been input, issues the warning to the operator.

Next, the case where a bias occurs in the amount of molten slag dripping from the pair of slag taps 55 will be described.

For example, when the molten slag is biased towards one of the pair of slag taps 55 and the amount of molten slag dripping from the other is decreased, the sound pressure level of the underwater sound corresponding to the molten slag dripping from the other slag tap 55 is lowered, and the sound pressure level for the other slag tap 55 detected by the hydrophone 2 is lowered.

On the other hand, because the sound pressure level of the underwater sound produced by the molten slag flowing out from the one slag tap 55 at least is not lowered, the sound pressure level for the one slag tap 55 detected by the hydrophone 2 is not lowered.

In other words, because the hydrophone 2 is disposed at the point where the distance from the one slag tap 55 and the distance from the other slag tap 55 are substantially equal, the influence of the decrease of the sound pressure level is reduced compared with a case where the hydrophone 2 is disposed at a position closer to the other slag tap 55, for example.

According to the above-described configuration, because the hydrophone 2 is disposed substantially equidistant from each of the pair of slag taps 55, even if the amount of molten slag flowing out from the pair of slag taps 55 is biased towards the one slag tap 55, for example, the influence of the decrease of the sound pressure level detected by the hydrophone 2 is reduced. Therefore, lowering of the detection accuracy of the slag discharge condition due to scaling-up of the coal gasification facility, especially the coal gasification furnace, can be prevented.

Note that, as in the above-described embodiment, the slag discharge condition monitoring apparatus 1 may issue the warning when the molten slag is not dripping or dripping intermittently, or it may merely determine whether the molten slag is dripping or not-dripping; it is not particularly limited.

### Second Embodiment

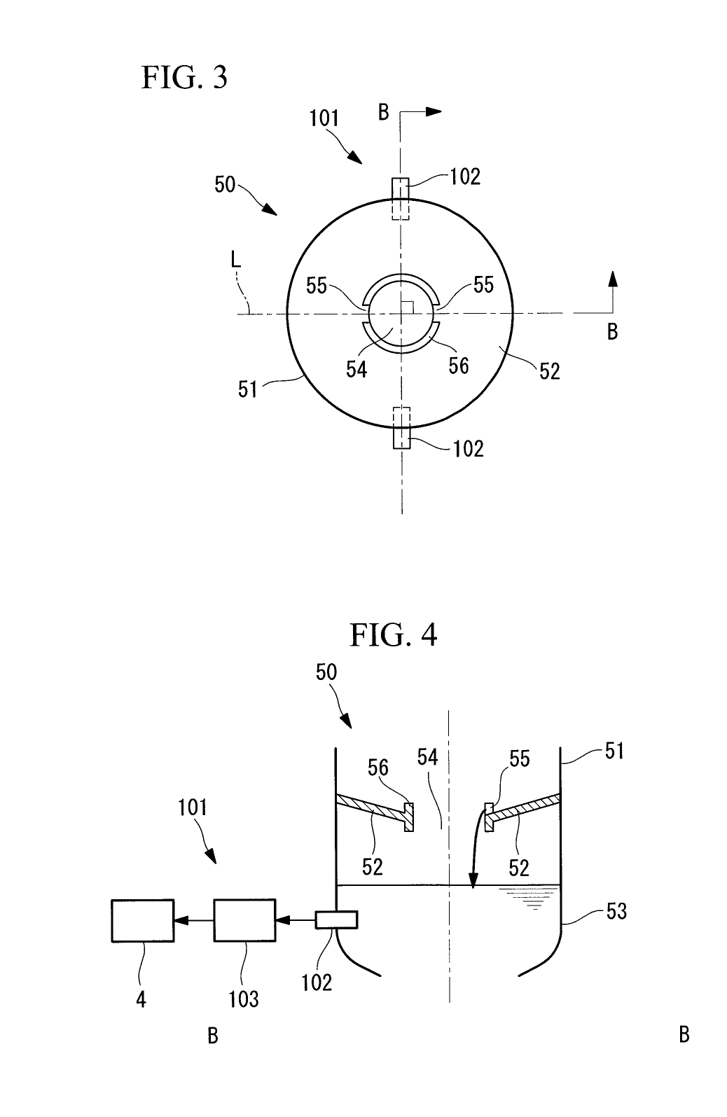

Next, a second embodiment of the present invention will be described with reference to FIGS. 3 and 4.

The basic configuration of the slag discharge condition monitoring apparatus of this embodiment is the same as the first embodiment but differs from the first embodiment in the arrangement of the hydrophones. Therefore, in this embodiment, only the arrangement of the hydrophones will be described using FIGS. 3 and 4, and descriptions of other components, etc. will be omitted.

FIG. 3 is a top view for explaining the configuration of the slag discharge condition monitoring apparatus according to this embodiment. FIG. 4 a cross-sectional view taken along B-B for explaining, in outline, the slag discharge condition monitoring apparatus of FIG. 3.

Note that the components identical to those of the first embodiment are given the same reference numerals, and the descriptions thereof will be omitted.

As shown in FIGS. 3 and 4, the slag discharge condition monitoring apparatus 101 of this embodiment is provided with a pair of hydrophones (underwater microphones) 102 that detect the underwater sound in the cooling water in the slag hopper 53, the determination unit (computing unit) 103 that determines the dripping state of the molten slag on the basis of the underwater sound detected, and the warning unit 4 that issues the warning on the basis of the determination result.

As shown in FIGS. 3 and 4, the hydrophones 102 are disposed in the cooling water in the slag hopper 53, and at the same time, are disposed at positions equidistant from the pair of slag taps 55. In other words, the hydrophones 102 are disposed on the line extending substantially perpendicular to the line L from the midpoint of the pair of slag taps 55 so that the slag taps 55 are positioned therebetween.

The determination unit 103 calculates an average value of the respective sound pressure levels of the underwater sound detected by the pair of hydrophones 102, and determines the presence and absence etc. of the molten slag dripping into the cooling water from the pair of slag taps 55 on the basis of the calculated average value.

Detection signals output from the hydrophones 2 are input to the determination unit 103, and the control signal is output from the determination unit 103 to the warning unit 4.

Next, the operation of the slag discharge condition monitoring apparatus 101 of the above-described configuration, especially in the case where the entry points into water of the molten slag dripping from the pair of slag taps 55 are deviated towards the side of one of the hydrophones 102, will be explained.

If the positions where the molten slag drips into the cooling water are deviated towards the side of the one hydrophone 102, the sound pressure level detected by the one hydrophone 102 is increased. On the other hand, the sound pressure level detected by the other hydrophone 102 is lowered.

The detection signals from the one hydrophone 102 and the other hydrophone 102 are input to the determination unit 103, and in the determination unit 103, the average value of the sound pressure levels detected by the one and the other hydrophones 102 is calculated from both detection signals.

The determination unit 103 determines the dripping state of the molten slag on the basis of the calculated average value of the sound pressure levels.

With the above-described configuration, because the pair of hydrophones 102 are disposed substantially equidistant from each of the slag taps 55, even if the amount of molten slag flowing out from the pair of slag taps 55 is biased towards the one hydrophone 102, for example, the sound is detected by the pair of hydrophones 102, and so, the influence of the decrease of the sound pressure level is reduced. In addition, because the average value of the sound pressure levels detected by each hydrophone 102 is calculated, the influence of the decrease of the sound pressure levels detected by the hydrophones 102 can be reduced further.

### Third Embodiment

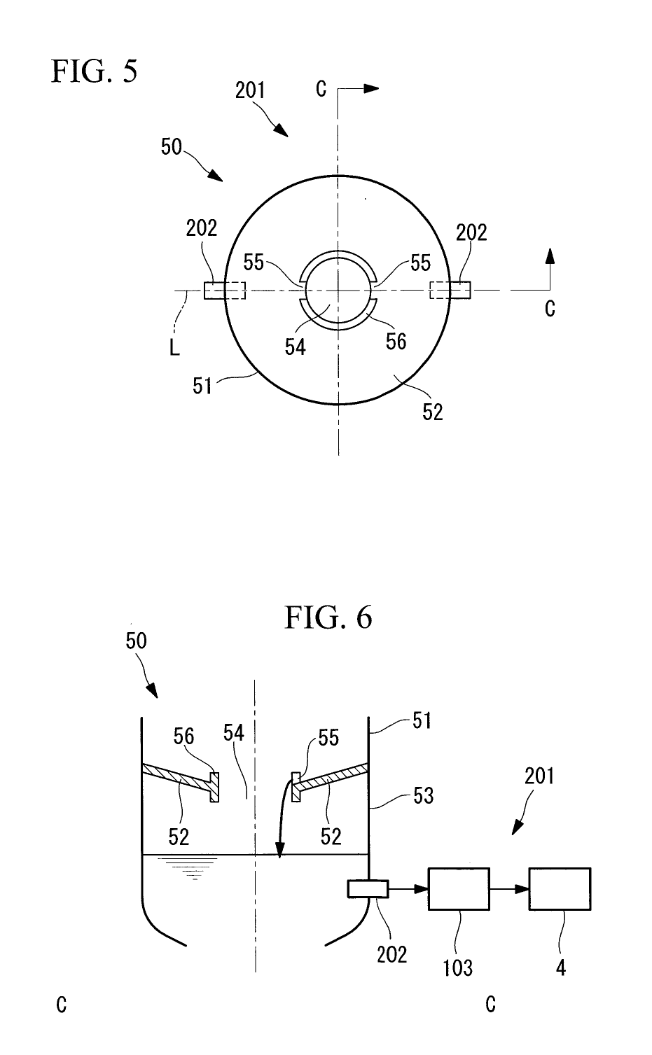

Next, a third embodiment of the present invention will be described with reference to FIG. 5 and FIG. 6.

The basic configuration of the slag discharge condition monitoring apparatus of this embodiment is the same as the first embodiment but differs from the first embodiment in the arrangement of the hydrophones. Therefore, in this embodiment, only the arrangement of the hydrophones will be described using FIGS. 5 and 6, and descriptions of other components, etc. will be omitted.

FIG. 5 is a top view for explaining the configuration of a slag discharge condition monitoring apparatus according to this embodiment. FIG. 6 is a cross-sectional view taken along C-C for explaining, in outline, the slag discharge condition monitoring apparatus of FIG. 5.

Note that the components identical to those of the first embodiment are given the same reference numerals, and the descriptions thereof will be omitted.

As shown in FIGS. 5 and 6, the slag discharge condition monitoring apparatus 201 of this embodiment is provided with a pair of hydrophones (underwater microphones) 202 that detect the underwater sound in the cooling water in the slag hopper 53, the determination unit 103 that determines the dripping state of the molten slag on the basis of the underwater sound detected, and the warning unit 4 that issues a warning on the basis of the determination result.

As shown in FIGS. 5 and 6, the hydrophones 202 are disposed in the cooling water in the slag hopper 53, and at the same time, are disposed opposite each other on the line L on which the pair of slag taps 55 are disposed, so that the pair of slag taps 55 are positioned therebetween.

Next, the operation of the slag discharge condition monitoring apparatus 201 of the above-described configuration, especially in the case where the amount of molten slag dripping from the pair of slag taps 55 is biased towards the side of one of the hydrophones 202, will be explained.

If the amount of molten slag dripping is biased towards the side of the one hydrophone 202, the sound pressure level detected by the one hydrophone 202 is increased. On the other hand, the sound pressure level detected by the other hydrophone 202 is lowered.

The detection signals from the one hydrophone 202 and the other hydrophone 202 are input to the determination unit 103, and the average value of the sound pressure levels detected by the one and the other hydrophones 202 is calculated from both detection signals in the determination unit 103.

The determination unit 103 determines the dripping state of the molten slag on the basis of the calculated average value of the sound pressure levels.

With the above-described configuration, by calculating the average value of the sound pressure levels of the underwater sound measured by the pair of hydrophones 202, even if the amount of molten slag flowing out from the pair of slag taps 55 is biased towards one of the slag taps 55, for example, the influence of the decrease of the sound pressure levels detected by the hydrophones 202 can be made even smaller.

### Fourth Embodiment

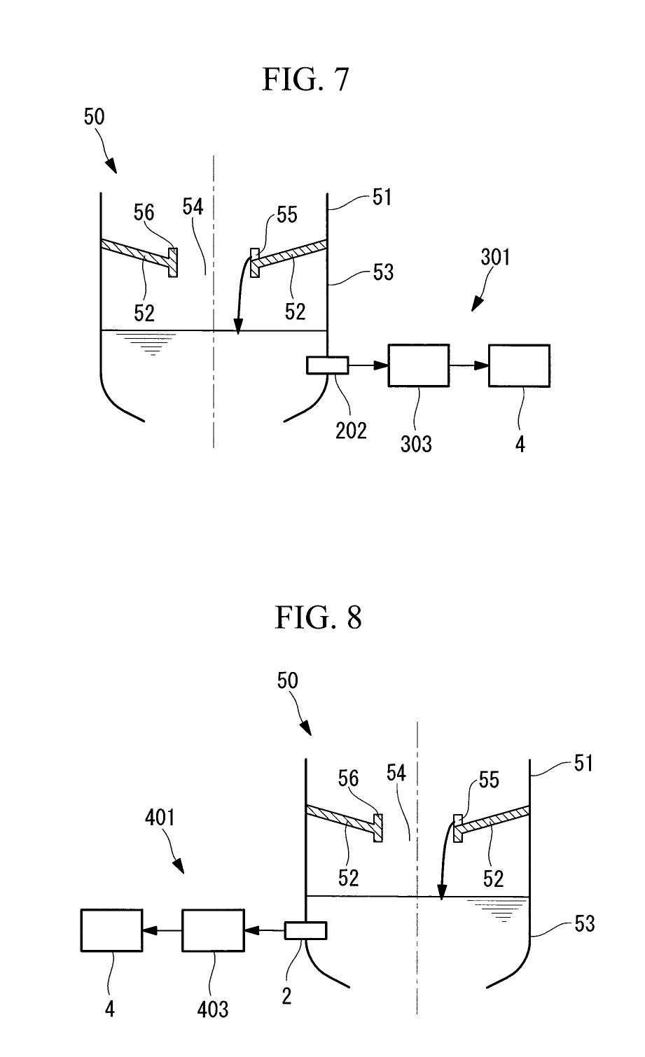

Next, a fourth embodiment of the present invention will be described with reference to FIG. 7.

Although the basic configuration of the slag discharge condition monitoring apparatus of this embodiment is the same as the third embodiment, it differs from the third embodiment in the calculation method of the detection signal. Therefore, in this embodiment, only the calculation method of the detection signal and related matter will be described using FIG. 7, and descriptions of other components, etc. will be omitted.

FIG. 7 is a cross-sectional view for explaining the configuration of a slag discharge condition monitoring apparatus according to this embodiment.

Note that the components identical to those of the third embodiment are given the same reference numerals, and the descriptions thereof will be omitted.

As shown in FIG. 7, the slag discharge condition monitoring apparatus 301 of this embodiment is provided with the pair of hydrophones 202 that detect the underwater sound in the cooling water in the slag hopper 53, the determination unit (computing unit) 303 that determines the dripping state of the molten slag on the basis of the underwater sound detected, and the warning unit 4 that issues a warning on the basis of the determination result.

The determination unit 303 calculates the difference between the respective sound pressure levels of the underwater sound detected by the pair of hydrophones 202, and determines the presence and absence etc. of the molten slag dripping into the cooling water from the pair of slag taps 55 on the basis of the calculated difference value.

Detection signals output from the hydrophones 202 are input to the determination unit 303, and the control signal is output from the determination unit 303 to the warning unit 4.

Next, the operation of the slag discharge condition monitoring apparatus 301 of the above-described configuration, especially in the case where the dripping of the molten slag from one of the pair of slag taps 55 is stopped, will be explained.

If the dripping of the molten slag from the other slag tap 55 among the pair of slag taps 55 is stopped, the sound pressure level detected by the one hydrophone 202 is lowered slightly because the molten slag is not dripping at the distal slag tap 55. On the other hand, the sound pressure level detected by the other hydrophone 202 is lowered greatly, compared with the lowering of the sound pressure level for the one hydrophone 202, because the molten slag is not dripping at the proximal slag tap.

The detection signals from the one hydrophone 202 and the other hydrophone 202 are input to the determination unit 303, and in the determination unit 303, the value of the difference between the sound pressure levels detected by the one and the other hydrophones 202 is calculated from both detection signals.

The determination unit 303 determines whether the dripping of the molten slag has been stopped, or at which slag tap 55 the dripping of the molten slag has been stopped, on the basis of the calculated value of the difference between the sound pressure levels and related data saved in advance.

Note that, the related data is data etc. that is stored by measuring, in advance, values of difference between the sound pressure levels and so forth for the case where the molten slag is dripping only from the one or the other slag tap 55.

With the above-described configuration, by obtaining the value of the difference between the sound pressure levels detected by the pair of hydrophones 202, the presence and absence of the molten slag dripping at the one and the other of the pair of slag taps 55 can be determined.

### Fifth Embodiment

Next, a fifth embodiment of the present invention will be described with reference to FIGS. 8 to 11.

Although the basic configuration of the slag discharge condition monitoring apparatus of this embodiment is similar to the first embodiment, it differs from the first embodiment in the calculation method of the detection signal. Therefore, in this embodiment, only the calculation method of the detection signal and related matter will be described using FIGS. 8 to 11, and descriptions of other components, etc. will be omitted.

FIG. 8 is a cross-sectional view for explaining the configuration of a slag discharge condition monitoring apparatus according to this embodiment.

Note that the components identical to those of the first embodiment are given the same reference numerals, and the descriptions thereof will be omitted.

As shown in FIG. 8, the slag discharge condition monitoring apparatus 401 of this embodiment is provided with the pair of hydrophones 2 that detect the underwater sound in the cooling water in the slag hopper 53, the determination unit (computing unit) 403 that determines the dripping state of the molten slag on the basis of the underwater sound detected, and the warning unit 4 that issues a warning on the basis of the determination result.

The determination unit 403 determines the dripping state of the molten slag on the basis of the sound pressure levels in two frequency bands in the underwater sound detected by the hydrophones 2.

Detection signals output from the hydrophones 2 are input to the determination unit 403, and the control signal is output from the determination unit 403 to the warning unit 4.

Next, the operation of the slag discharge condition monitoring apparatus 401 of the above-described configuration, especially with regard to the determination of the dripping state of the molten slag from the slag taps 55 into the cooling water will be described.

The molten slag dripping from the slag taps 55 into the cooling water makes different underwater sounds depending on the dripping state. The underwater sound is detected by the hydrophones 2, and the detection signal is input to the determination unit 303.

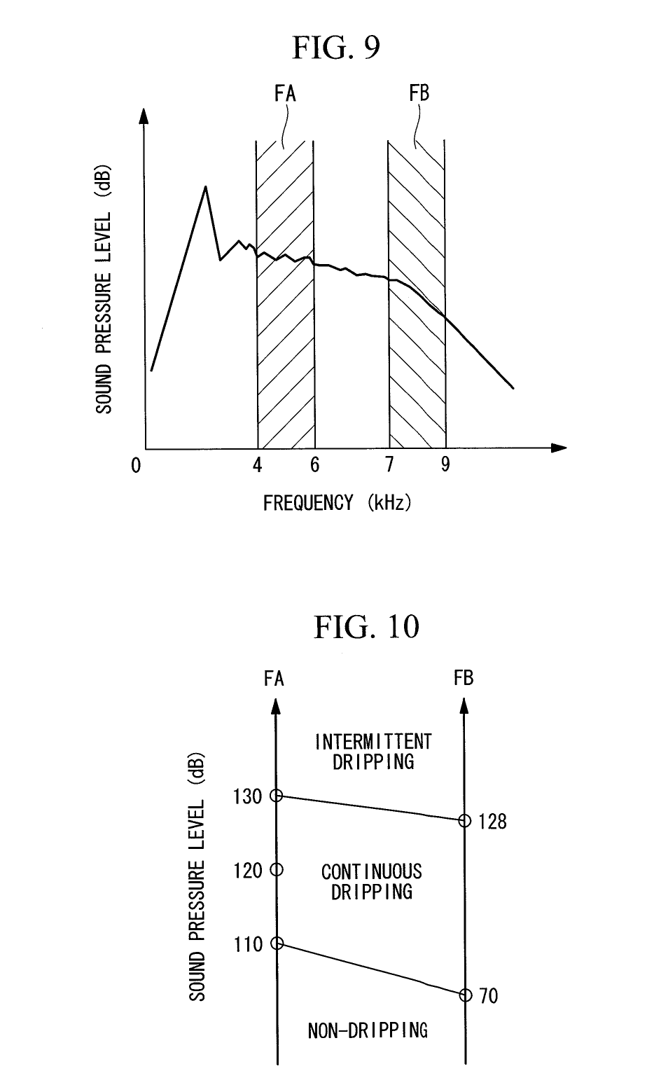

FIG. 9 is a graph for explaining the relationship between waveforms and frequency bands of underwater sound detected by the hydrophones in FIG. 8.

The determination unit 303 conducts a frequency analysis of the raw waveform of the underwater sound detected by the hydrophones 2 and calculates, as shown in FIG. 9, the average sound pressure levels in two frequency bands FA and FB. In this embodiment, frequency bands will be described as applied to an example in which a band from 4 kHz to 6 kHz (5 kHz band) is set as the frequency band FA, a band from 7 kHz to 9 kHz (8 kHz band) is set as the frequency band FB.

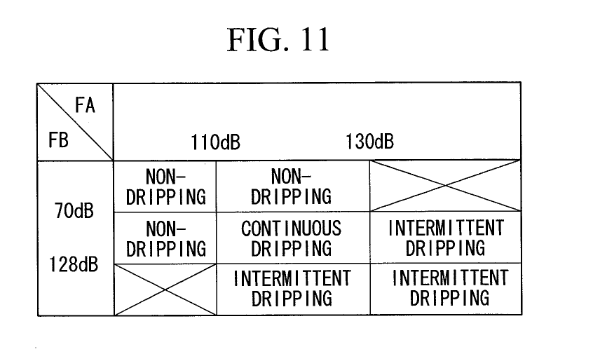

FIGS. 10 and 11 are diagrams for explaining maps used for determining the dripping state of the molten slag in the determination unit in FIG. 8.

After calculating the average sound pressure levels in the two frequency bands FA and FB, the determination unit 303 determines the dripping state of the molten slag on the basis of the map shown in FIG. 10 or FIG. 11 and the average sound pressure level.

For example, if the average sound pressure level in the frequency band FA is less than about 110 dB, and the average sound pressure level in the frequency band FB is less than about 70 dB, regardless of the average sound pressure level in the other frequency band, it is determined that the molten slag is not dripping.

On the other hand, if the average sound pressure level in the frequency band FA is equal to or more than about 130 dB, and the average sound pressure level in the frequency band FB is equal to or more than about 128 dB, regardless of the average sound pressure level in the other frequency band, it is determined that the molten slag is intermittently dripping.

In addition, if the average sound pressure level in the frequency band FA is equal to or more than about 110 dB and less than about 130 dB, and if the average sound pressure level in the frequency band FB is equal to or more than about 70 dB and less than about 128 dB, then it is determined that the molten slag is dripping continuously.

Note that, the frequency band of the underwater sound detected by the hydrophones 2 depends on the hydrophones used (for example, 200 kHz); it is not particularly limited.

With the above-described configuration, the dripping state of the molten slag, for example, states such as non-dripping, continuous-dripping, and intermittent-dripping, can be determined on the basis of the average sound pressure levels in the two frequency bands FA and FB. In other words, if the dripping state of the molten slag is changed, the waveform of the underwater sound produced when the molten slag and the cooling water are brought into contact will also change; therefore, based on the average sound pressure levels in the two frequency bands FA and FB, it is possible to determine to which dripping state-related underwater sound the detected underwater sound corresponds, and thus it is possible to determine the dripping state of the molten slag.

1. A slag discharge condition monitoring apparatus provided in a furnace facility that processes molten slag produced within a furnace by dripping the molten slag from a slag hole provided on a furnace bottom into cooling water outside the furnace, the slag discharge condition monitoring apparatus comprising:
an underwater microphone that is provided in the cooling water substantially equidistant from each of a pair of slag taps that are disposed opposite each other and that cause the molten slag to flow into the slag hole.

2. A slag discharge condition monitoring apparatus according to claim 1, wherein the underwater microphones are a pair of underwater microphones disposed opposite each other and equidistant from each of the pair of slag taps, and
wherein a computing unit that calculates an average value of the sound pressure levels detected by the pair of underwater microphones is provided.

3. A slag discharge condition monitoring apparatus comprising, in a furnace facility that processes molten slag produced within a furnace by dripping the molten slag from a slag hole provided on a furnace bottom into cooling water outside the furnace:
a pair of underwater microphones that are disposed opposite each other in the cooling water and a pair of slag taps that are disposed opposite each other and that cause the molten slag to flow into the slag hole, each of the pair of underwater microphones and each of the pair of slag taps being disposed on substantially the same line; and
a computing unit that calculates an average value of sound pressure levels detected by the pair of underwater microphones.

4. A slag discharge condition monitoring apparatus according to claim 3, further comprising a determination unit that determines the presence and absence of the molten slag dripping into the cooling water from the one and the other of the pair of slag taps, respectively, on the basis of the difference between the sound pressure levels detected by the pair of underwater microphones.

5. A slag discharge condition monitoring apparatus according to claim 1, further comprising a determination unit that calculates sound pressure levels in a plurality of frequency bands of underwater sound detected by the underwater microphone, and that determines a dripping state of the molten slag on the basis of the sound pressure level in each frequency band.

6. A slag discharge condition monitoring apparatus comprising, in a furnace facility that processes molten slag produced within a furnace by dripping the molten slag from a slag hole provided on a furnace bottom into cooling water outside the furnace:
an underwater microphone disposed in the cooling water; and
a determination unit that calculates sound pressure levels in a plurality of frequency bands of underwater sound detected at the underwater microphone, and that determines a dripping state of the molten slag on the basis of the sound pressure level in each frequency band.

7. A method for monitoring a slag discharge condition in a furnace facility that processes molten slag produced within a furnace by dripping the molten slag from a slag hole provided on a furnace bottom into cooling water outside the furnace, the method for monitoring a slag discharge condition comprising:
a detection step of detecting the underwater sound in the cooling water by an underwater microphone disposed in the cooling water; and
a determination step of determining the dripping state of the molten slag into the cooling water on the basis of the detected sound pressure level of the underwater sound.
